(19) United States
(12) Patent Application Publication
(10) Pub. No.: US 2002/0013746 A1
(43) Pub. Date: Jan. 31, 2002

(54) Method and system of uniquely identifying real estate

(75) Inventors: Gregory M. Bibas, New Canaan, CT (US); Richard J. Roll, Stamford, CT (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: RealHome.com

(21) Appl. No.: 09/878,506

(22) Filed: Jun. 11, 2001

Related U.S. Application Data
(60) Provisional application No. 60/221,813, filed on Jul. 31, 2000.

(51) Int. Cl. G06F 17/60

(52) U.S. Cl. 705/28

(57) ABSTRACT

The method and the system of the present invention provide for uniquely identifying a real estate property. A universal identifier associated with a real estate property permits a user to request information related to the real estate property, submit the request to a host system and receive a fulfillment of the information request by the host system and/or a data provider linked to the host system. The fulfillment includes an identifier that is unique, and preferably permanently, associated with the real estate property. The universal identifier may be based on a base code and a series code or a base code and a country code.

### BACKGROUND OF THE INVENTION

1. Field of the Invention

The present invention relates to identification systems and, in particular, to a method and a system for identifying, storing and accessing information related to real estate property.

2. Description of the Related Art

There are various information systems that associate a unique identifier with a unique entity and the information organized by the information system. The unique identifier is used by the information system to attempt to improve the storage, access and analysis capabilities of the information system. Examples of unique identifiers used by information systems include, but are not limited to, social security numbers issued by the federal government; Uniform Stock Keeping Units (SKU's) issued by large retailers; Universal Product Codes (UPC's) issued by manufacturers; driver license numbers issued by the individual states; model and serial numbers assigned to products by manufactures; invoice numbers used by businesses; and phone numbers issued by phone companies.

The information identifiers used by various information systems tend to be unique to each system. Therefore, the information identifier used by one system is usually not compatible in another systems. Also, within the same system, conflicts may arise due to the similarities of the information being organized, stored and/or tracked. For example, 100 Maple Street in Liberty City, Calif. and 100 Maple Street in Liberty City, Ga. most probably will cause a conflict within a system that relies on the postal address using only the street address and city as the information identifier, as there is not enough information to make such an identifier unique.

The above examples illustrate the need for a standardized numbering system as a principle for organizing information access. While standardized numbering systems have been used to increase the speed and accuracy of access to and storage of information, they also account for and remove potential conflicts that occur due to similarities in the information being organized.

Current real estate identification systems are limited in their geographical scope of coverage and/or only provide a transitory method of identifying a real estate property that is not permanently and uniquely associated with the identifier. As such, realtors and other parties interested in locating and/or tracking a real estate property have no standard and permanent way of organizing, sorting, and accessing (i.e., managing) real estate information. Thus, there exists a need for a standardized system of managing information related to real estate properties.

### SUMMARY OF THE INVENTION

It is an object of the present invention to provide a method and/or a system that uniquely and permanently stores and provides access to real estate property information.

It is another object of the present invention to provide such a method that incorporates a database of supplied information that is managed by a system host.

It is another object of the present invention to provide such a method that incorporates access to external databases of information managed by a Data Provider and coordinated by a system host using a universal identifier.

It is yet another object of the present invention to provide such a method that allows a user to conduct customized queries of the system for specific information related to real estate property.

It is still another object of the present invention to provide such a method that compensates a data provider for providing information to the system.

It is still another object of the present invention to provide a method for data providers to have access to and control of their data and information relating to their data.

It is still yet another object of the present invention to provide such a method that permits expanded information and details about the real estate property to be contained in the system.

It is a further object of the present invention to provide a real estate identification system that is secure.

Accordingly, the present invention includes a method and a system for systematically and permanently identifying, organizing, storing, accessing, or otherwise managing data related to real estate property. The system provides a universal identifier for each property. The universal identifier is uniquely associated with only one real estate property. In general, the universal identifier may be based on a base code and a series code or a base code and a country code. In one aspect, the base code is based on the U.S. Postal Service (USPS) assigned zip+4 address. The universal identifier can also contain, uniquely, the electronic mail (e-mail) address and e-mail forwarding address for each residential address in the U.S.

The method includes requesting data for the real estate property; obtaining the requested data, whether locally or remotely located, from a data provider and at the cost established by the data provider and/or host; assigning a universal identifier to the real estate property that is unique to the real estate property and preferably permanently associated with the real estate property; and providing the data requested upon satisfaction of the access controls established by the system. The costs associated with obtaining the data, if any, may be in the form of money and/or an exchange of data. A user may request data using structured data queries.

While the present invention will be discussed primarily in the context of providing a unique identifier for identifying real estate property in a real estate and real estate buying/selling context for a consumer of residential property information, the present invention can be adopted to a number of applications. The applications include, but are not limited to, delivery services; insurance, lending and other product/service providers; tax information providers; government control systems; demographic and economic data providers; and marketers.

### BRIEF DESCRIPTION OF THE DRAWINGS

FIG. 1 is a top level depiction of the present invention;

FIG. 2 is a depiction of a data requester device of the invention of FIG. 1;

FIG. 3 is a depiction of a data provider aspect of the invention of FIG. 1;

FIG. 4 is a depiction of a host system of the invention of FIG. 1;

FIG. 5 is a data structure for a public individual property data of FIG. 4;

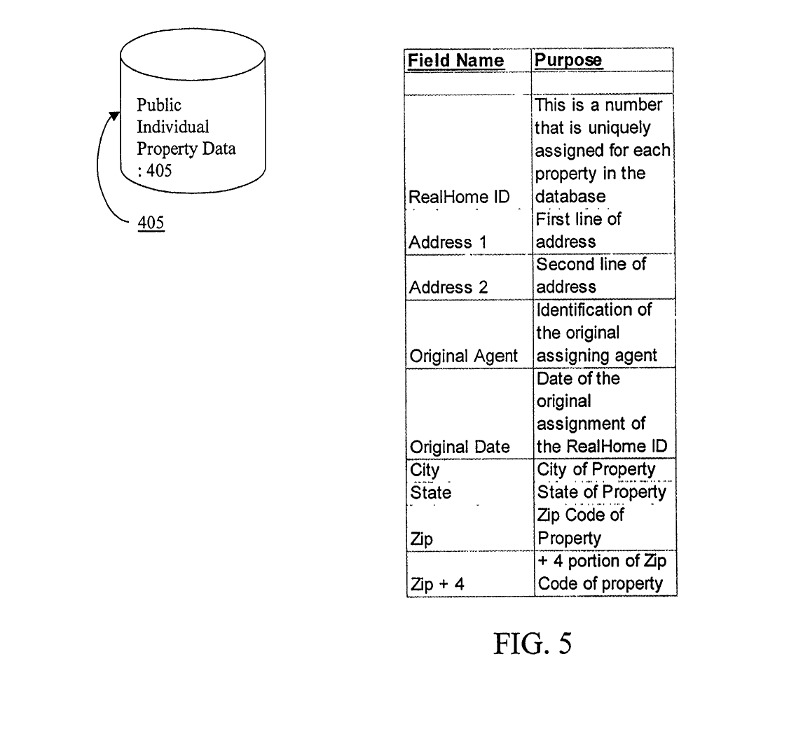

FIG. 6 is a data structure for a private individual property data of FIG. 4;

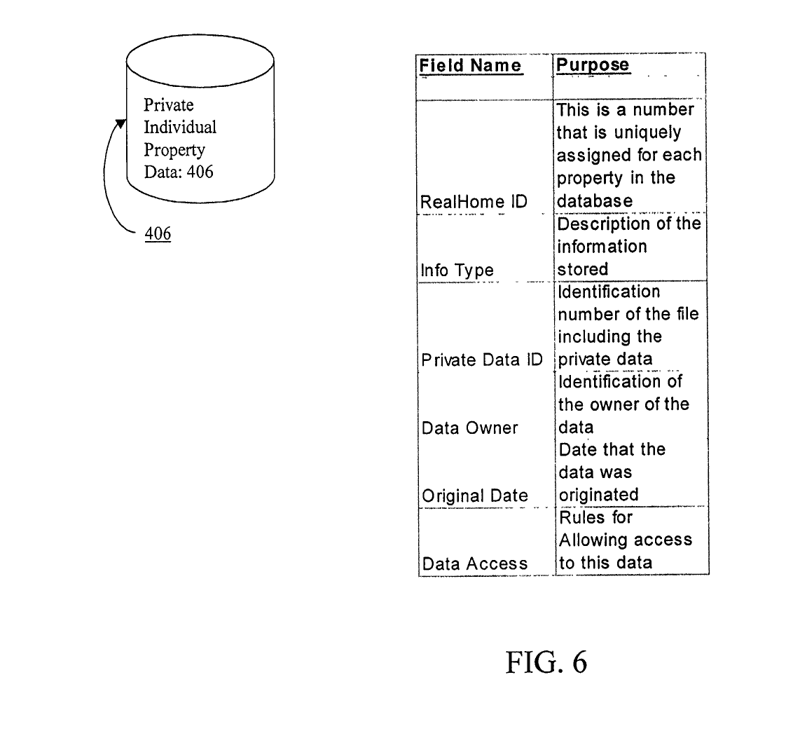

FIG. 7 is a data structure for a third party data of FIG. 4;

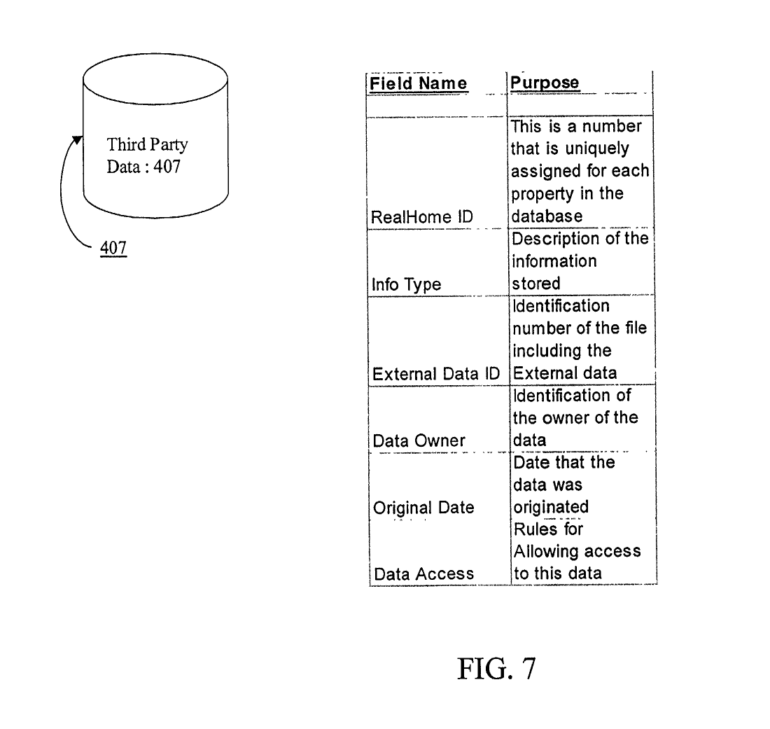

FIG. 8 is a data structure for a data owner/verification database of FIG. 4;

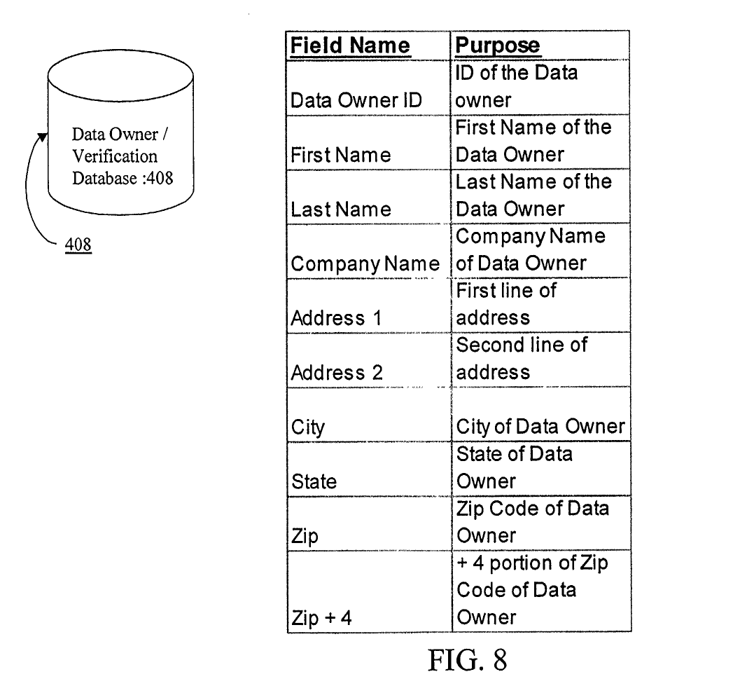

FIG. 9 is a flow diagram of the generation of a universal identifier for a real property in accordance with the present invention;

FIG. 10 is a flow diagram of a preferred method for loading data to a database in accordance with the present invention;

FIG. 11 is a flow diagram illustrating a storage and linkage of data provider supplied data in accordance with the present invention;

FIG. 12 is a flow diagram of an aspect of the present invention; and

FIG. 13 is a flow diagram of an aspect of the present invention for allowing data providers access to manage, update and otherwise control the data in the system database, which typically resides with a host system in accordance with the present invention.

### DETAILED DESCRIPTION OF THE INVENTION

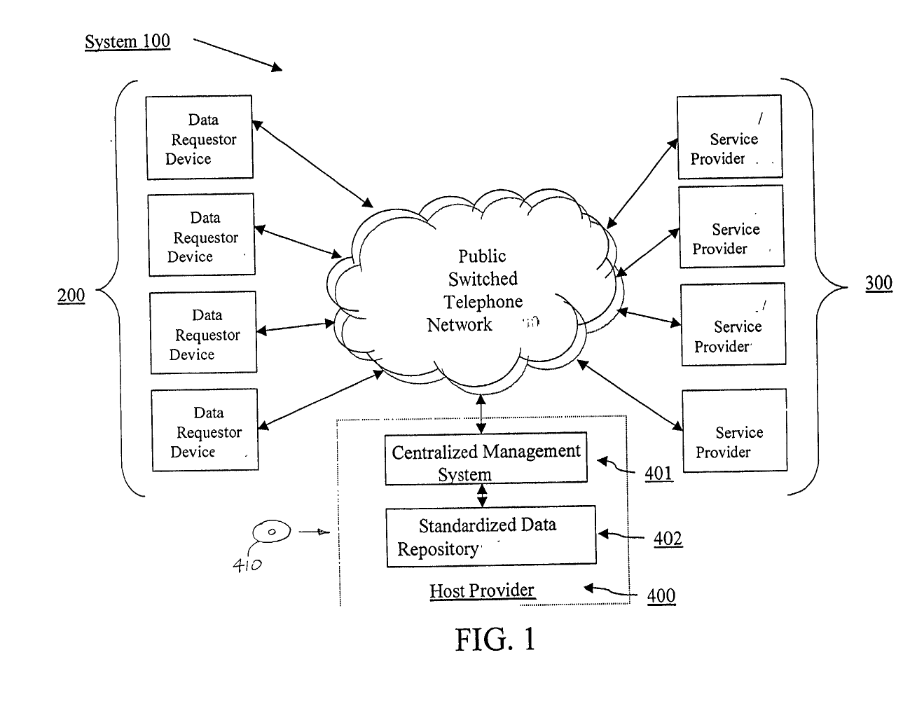

Referring to the drawings and, in particular, to FIG. 1, there is shown one embodiment of a system for managing real estate data generally represented by reference numeral 100, of the present invention. The management of real estate data includes, but is not limited to, storing, retrieving, exchanging, viewing, aggregating, and analyzing the real estate related data. The system systematically organizes and provides access to multiple data providers 300 and/or data provided by the data providers 300 in preferably a secure environment. The system or process enables a user to request data for a real estate property using a universal identifier and/or assigns a universal identifier that is distinct for the real estate property. The system also preferably manages data requests and compensates the data providers 300.

The system 100 has at least one data requester device 200; a communications network, in this particular embodiment a public switched telephone network 1000 (hereinafter PSTN); one or more data providers 300; and a host system 400, which also includes a centralized management system (CMS) 401 and a standardized data repository 402. The host system 400, the data requester devices 200 and the data providers 300 are preferably connected to a communications network 1000 through a bi-directional communication link.

Although depicted in FIG. 1 as a PSTN, the communications network 1000 can include a computer network such as the Internet or a LAN. The communications network 1000 can also include wireless, paging or cable networks, other communications networks, or a combination thereof for at least portions of the communication network used by the system 100.

Users of the system 100 access the system using a data requester device 200. The data requester device 200 typically provides a user interface to facilitate input of data (e.g., real estate property) requests. A data provider 300 offering access to its data through the system 100 accesses the system by way of the data providers 300. The flow of data between the data requester device 200, the data provider 300 and the host system 400 is preferably controlled and coordinated by a host system 400.

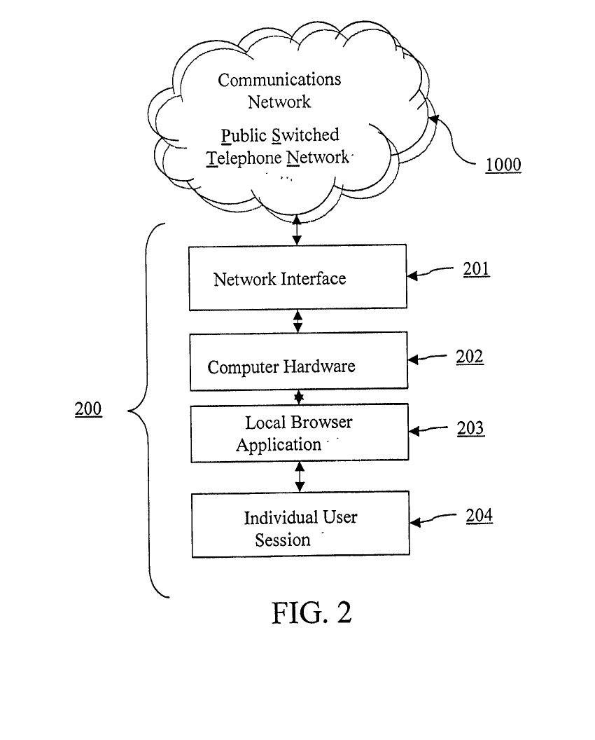

An embodiment of the data requester device 200 is depicted in FIG. 2. Typically, a user initiates an individual user session 204 on the data requester device 200. The data requester device 200 can be a personal computer, an Internet appliance, a handheld computer and/or personal digital assistant (PDA), a cell phone, or other devices enabled to communicate electronic information. Typically, a browser application 203 provides a user interface on the data requester device 200. The browser accesses the associated hardware 202 of the particular data requester device 200 and identifies the network interface 201 that facilitates access to the communications network 1000. The communications network 1000 is provides a communication link from the data requester device 200 to the host system 400.

The user can enter information into the data requester device 200 in a number of different ways, depending on the data requester device used. Such input devices include, but are not limited to, a keyboard, a mouse, a button selected menu, a scanning device, a voice recognition system, and other data input methods and/or devices whether automatic or manual in nature.

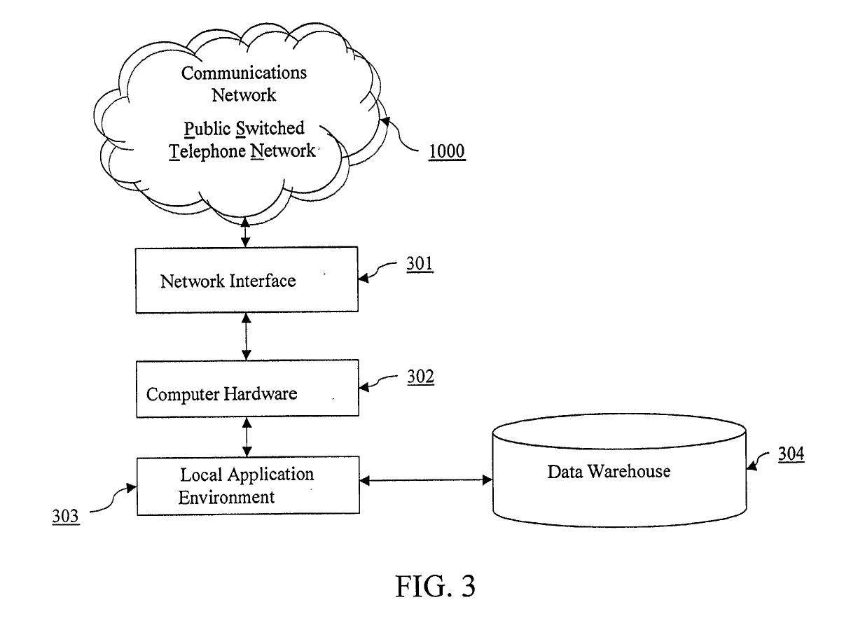

FIG. 3 illustrates an embodiment of the data provider system 300. Data related to the real estate resides in a data database 304. The data providers 300 may elect to provide information from a database connected to the system 100 or their own databases. The data provider 300 connects to the communications network 1000 via a network interface 301 that is accessible by the computer hardware 302. A local application environment 303 also resides and runs on the computer hardware 302. The local application environment 303 may include software operating systems, data management systems, database systems, and other software systems which allow for the management, access and local control of the data stored in the database 304.

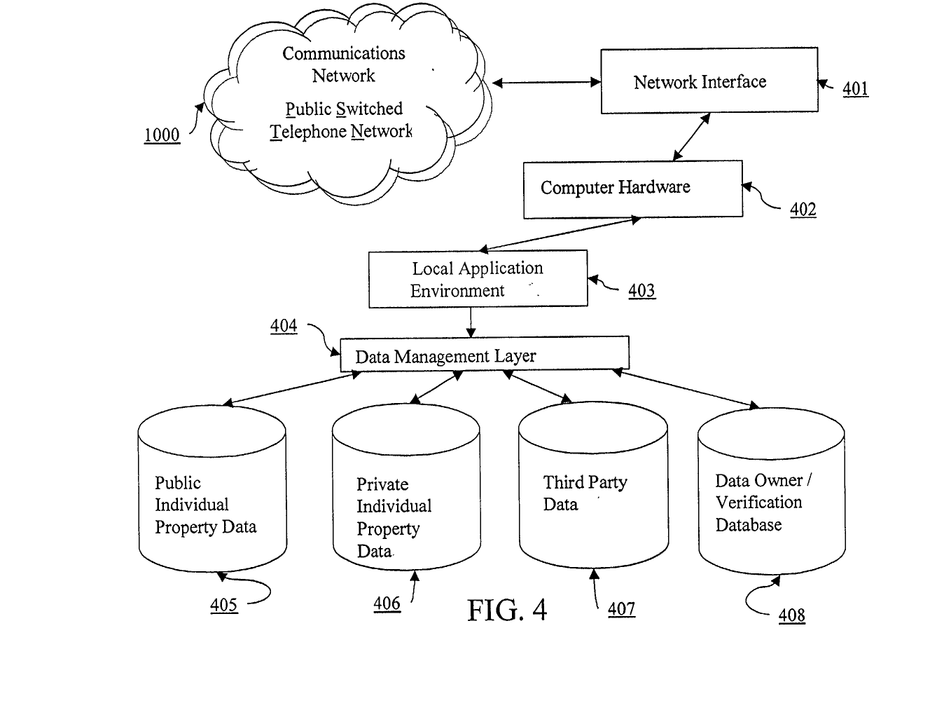

FIG. 4 illustrates an aspect of the host system 400. Various data repositories 405 to 408 within the host system 400 are controlled by a data management layer 404 within the host system 400. The data management layer 404 acts to control the flow, access, and storage of the data used by the invention. The control is based, at least in part, upon the authorization information provided in a real estate property data request. The data management layer 404 typically resides within a local application environment 403, that runs on associated computer hardware 402. Although expressed as hardware, the computer platform supporting the local application environment 402 may employ software and hardware or a combination thereof, to facilitate the operations of the host system 400. A network interface 401 communicates with the communications network 1000.

In operation, requests from a data requester device 200 are routed to the host system 400. The request is fulfilled by the host system 400 through the data management layer 404. The fulfillment is based on the availability of the requested real estate property data and the level of access and actions requested by a user.

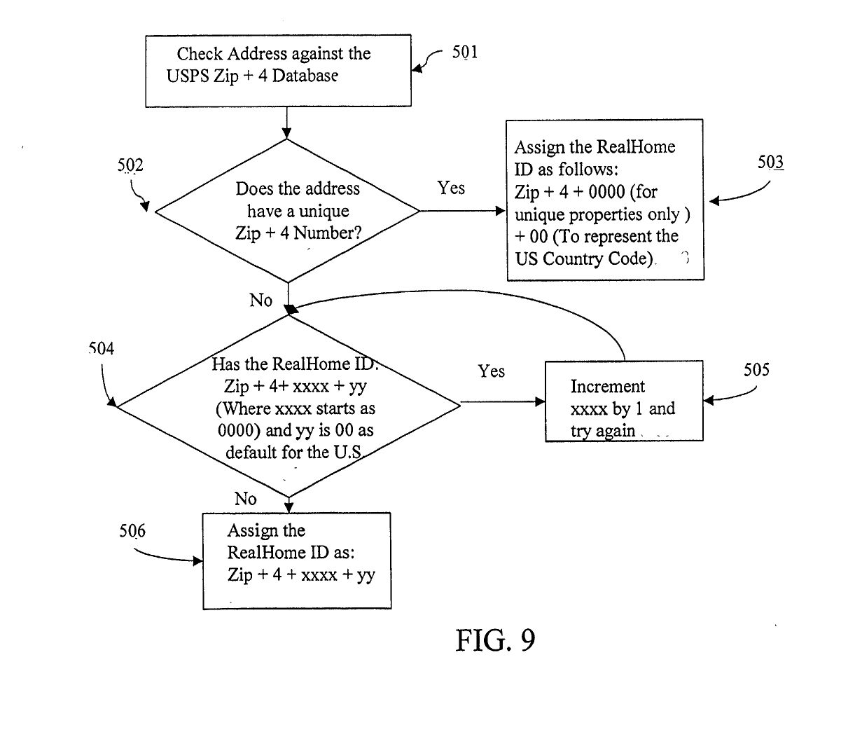

FIG. 9 is a flow diagram showing the generation of a universal identifier that is uniquely assigned to a real estate property in accordance with the present invention. In general, the universal identifier may be based on a base code and a series code or a base code and a country code. The universal identifier may further be generated for a real property by, for example, submitting the U.S. Postal Service (USPS) address of the property to the system and verifying the supplied USPS address against an USPS zip code+4 number contained in a USPS zip code+4 database (step 501). Preferably, the USPS zip code+4 database is updated regularly. If the USPS zip code+4 address supplied is unique within the host database, that is, not already assigned (step 502), then a series code of four trailing zeroes (0000) and a two digit country code is appended to the real estate property's USPS zip code+4 address (step 503).

The series code of four trailing zeroes indicates that the associated property is the first property having the base USPS zip code+4 address. Subsequent properties sharing the same base USPS zip code+4 address will be distinguished by, for example at least, a different series code (e.g., 0001, 0002 . . . xxxx). The country code will vary, depending on where the property is located. For properties located in the United States, the country code is 00. Thus, the assigned identifier for a property having an USPS zip code+4 address and located in the U.S. is the uniquely generated identifier of USPS zip code+4+0000+00. In an aspect of the present invention, the country code indicative of the U.S., 00, may be omitted and assumed (i.e., the default country the U.S.).

If the USPS zip code+4 address for the property is not unique to the USPS database as determined in step 502, then a determination is made to see if the USPS zip code+4 address is unique to the system (step 504). This determination is done by verifying the USPS zip code +4 (i.e., base code) against the system's ID database. If the USPS zip code+4 numbering is unique to the system's ID database (i.e., no other property in the system has this identifier, that is has the same base USPS zip code+4 numbering) then the property is assigned the unique identifier of USPS zip code+4+0000+00. If the base USPS zip code+4 numbering is not unique or distinct from all other real estate properties ID's in the system ID database, then the series code is recursively incremented by 1 (steps 504 and 505) until a unique identifier is obtained. Once a distinct or unique identifier is obtained in step 504, the system assigns the identifier to the real estate property (step 506).

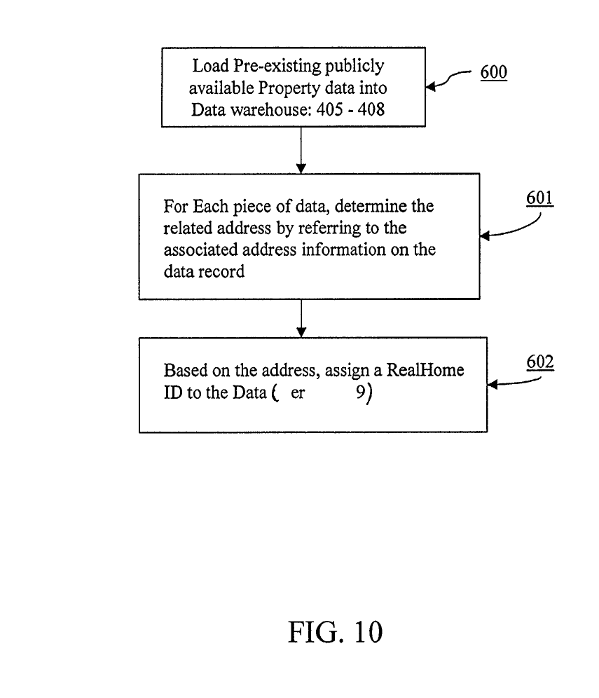

FIG. 10 is a flow diagram of a preferred method for loading data to a database of the host system and assigning a unique ID to that data. Thus, the newly loaded data is associated with the relevant property, in accordance with the invention. Data, such as, for example, an updated version of the U.S. Postal Service Data of the Zip+4 database, can be loaded to the system, by this process. The data is loaded to a memory (step 600). Each piece of newly loaded data is associated with a related property address (step 601). Based on the property's address, a universal identifier is assigned to the data (step 602). The updated data is then stored in the system database or referenced, as described in greater detail below.

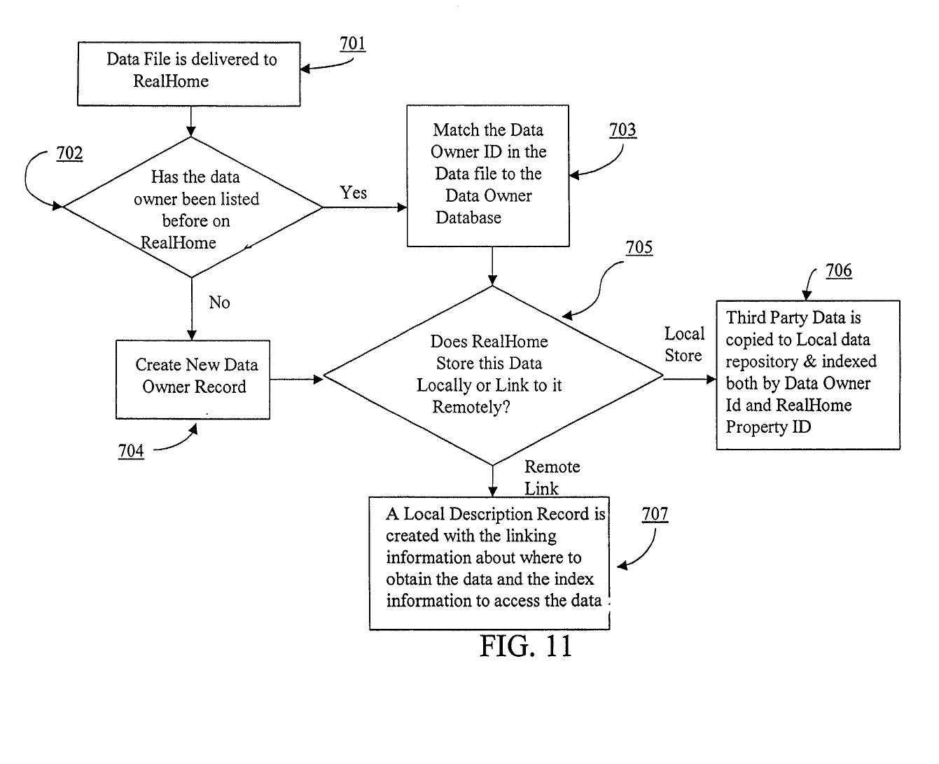

FIG. 11 is a flow diagram illustrating the storage and association of the data supplied to the system by a data provider. A determination is made whether the data provider 300 has previously listed or otherwise provided data to the system (step 702). If the data provider 300 has previously provided data to the system 100, then the system 100 appends the data to the data provider's existing database (step 703). If a determination is made that the data provider 300 has not previously listed data with the system or if there is no longer a database for the data provider 300 available, then a new database is created for the data provider (step 704). In either case, the system 100 makes a determination (step 705) based on the information provided in the data file and data owner record whether the data is stored locally (step 706) or remotely (707) and stores the data provider's data accordingly.

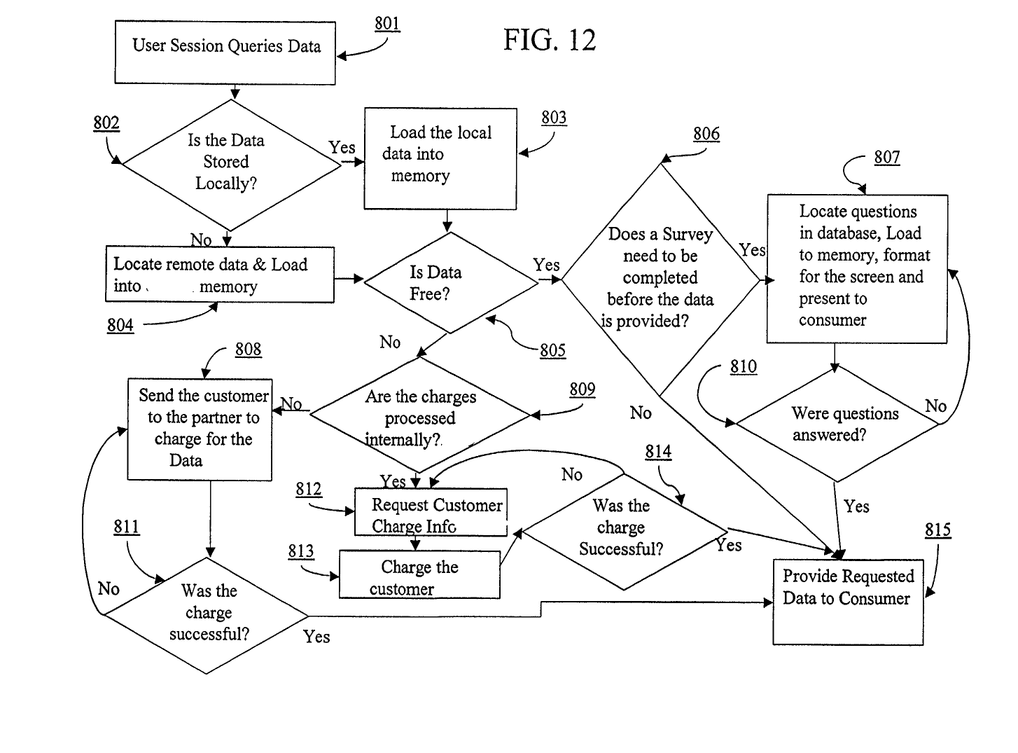

FIG. 12 is a flow diagram of an aspect of the present invention. As shown in FIG. 12, a user initiates a real estate property data request by submitting the data request to the system 400 (step 801). The system, preferably the host system, determines (step 802) whether the requested information is stored locally (step 803) or remotely (step 804). In either case, the requested data is loaded into the system's memory (step 803 or 804). A determination is also made to determine whether there is a monetary fee associated with obtaining the requested data (step 805). If a monetary fee is associated with the acquisition of the requested data, then the data provider is compensated for allowing access to the data (steps 808 to 814). The monetary compensation may be in the form of a subscription fee, license, a transaction fee, etc. This is an illustrative example of how the data providers can be compensated. However, other compensation triggers and/or models can be incorporated into the present invention without departing from the scope thereof.

Once the fee is successfully charged to the data requesting user, either by the host system (steps 812 to 814) or the data provider (steps 808, 811), the requested data is provided to the user making the data request (step 815).

FIG. 12 also illustrates the instance where a questionnaire or survey can be required prior to the access or the release of the requested data from a data provider (steps 806, 807 and 810). FIG. 12, steps 806,807,810, is a form of data provider compensation. The data provider (e.g., data provider 300 or the host system 400) may also be compensated by an exchange of data between the data provider and the data requester. Once the questionnaire is answered, the requested data is provided to the user making the data request (step 815).

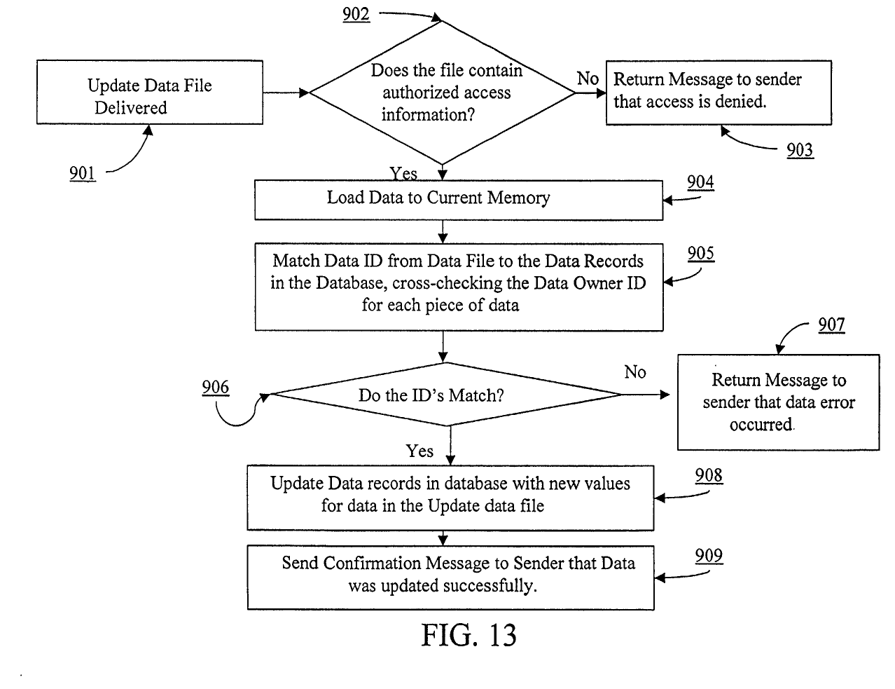

FIG. 13 is a flow diagram of an aspect of the present invention that allows data providers access to manage, update and otherwise control the data in the system database. The real estate data management aspects shown typically reside with the host system 400. An update data file (step 901) may be periodically required to keep the database updated. The update data file is analyzed to determine if it includes the authorized access information (step 902). If the update data file does not contain the required or authorized access information, then a message is returned to the sender, typically a data provider 300, that access is denied (step 903). If the file does include the authorized access information, then the data included in the file is loaded to current system memory (step 904). A data ID included in the update data file is matched to the data records in the database, with cross-checking performed on each record to verify the ID owner, or any other data updating technique(s) (step 905).

It is then determined (step 906) whether the data item and data owner identified in the update data file match. If there is not a match, then a message is returned to the data provider (step 907), with a copy of the individual data record, indicating that there is a data matching problem with the data update request. If the IDs do match (step 906), then the data record in the database is updated with the new data provided in the data update file (step 908). Upon the completion of step 908, a confirmation message is optionally sent to the data submitting data provider 300. The confirmation message informs the data provider that the stored data ha been updated (step 909).

It should be understood that the foregoing description is only illustrative of the present invention. Various alternatives and modification can be devised by those skilled in the art without departing from the present invention. Accordingly, the present invention is intended to embrace all such alternatives, modification and variances. For example, the present invention may be implemented by a computer readable storage media (e.g., a memory card or hard disk) having program instructions embodied therein for executing the methods of the present invention. The computer readable storage media can be read and executed by the system 100. Accordingly, the management of real estate data wherein the storage media includes program instructions for assigning a universal identifier to a real estate property, program instructions for associating data from a data store with the real estate property, program instructions for storing the data and the universal identifier in a memory, and program instructions for retrieving the data from the memory in response to a request. The storage media can be included in system 100 such as, but not limited to, the computer hardware 202, the local application browser application 203, the computer hardware 402, and the local application environment 403, or a removable storage media (e.g., CD-ROM 410, FIG. 1).

What we claim is:

1. A method of managing real estate data, said method comprising the steps of:
assigning a universal identifier to a real estate property;
associating data from a data store with the real estate property;
storing the data and the universal identifier in a memory; and
retrieving the data from said memory in response to a request.

2. The method of claim 1, including the step of generating the universal identifier.

3. The method of claim 1, wherein at least a portion of the request includes the universal identifier.

4. The method of claim 1, further including the step of compensating a data provider for supplying the data.

5. The method of claim 4, wherein the step of compensating comprises providing a monetary fee to the data provider.

6. The method of claim 4, wherein the step of compensating comprises an exchange of data between a data requester and the data provider.

7. The method of claim 1, wherein the step of retrieving comprises retrieving the requested data using a wired or wireless communication link.

8. The method of claim 1, wherein the universal identifier is based on a base code and a series code.

9. The method of claim 8, wherein the base code comprises a postal number.

10. The method of claim 8, based on a country code.

11. The method of claim 1, wherein the universal identifier is based on a base code and a country code.

12. The method of claim 11, wherein the base code comprises a postal number.

13. A system for managing real estate data, said system comprising:
a communication link;
a data store for storing data;
a host system for assigning a universal identifier with a real estate property, and for associating at least a portion of the data with the real estate property; and
a data request device for providing a request for the data associated with the real estate property to the host system using the communication link.

14. The system of claim 13, wherein the host system generates the universal identifier.

15. The system of claim 13, wherein the communication link is wired or wireless.

16. The system of claim 13, wherein the data request device includes a browser type user interface.

17. The system of claim 13, wherein the host system includes a security control for controlling access to the data.

18. The system of claim 13, wherein the universal identifier is based on a base code and a series code.

19. The system of claim 18, wherein the base code comprises a postal number.

20. The system of claim 18, wherein the universal identifier is based on a country code.

21. The system of claim 13, wherein the universal identifier is based on a base code and a country code.

22. The system of claim 21, wherein the base code comprises a postal number.

23. The system of claim 13, wherein the host system includes a control for compensating a data provider in exchange for supplying the requested data.

24. A storage medium having computer readable program instructions embodied therein for managing real estate data, said storage medium comprising:
program instructions for assigning a universal identifier to a real estate property;
program instructions for associating data from a data store with the real estate property;
program instructions for storing the data and the universal identifier in a memory; and
program instructions for retrieving the data from said memory in response to a request.

25. The storage medium of claim 24, further comprising program instructions for generating the universal identifier.

26. The storage medium of claim 24, further comprising program instructions for compensating a data provider for supplying the data.

27. The storage medium of claim 26, further comprising program instructions for compensating the data provider with a monetary fee.

28. The storage medium of claim 26, further comprising program instructions for compensating the data provider with an exchange of data from a data requester.

29. The storage medium of claim 24, further comprising program instructions for generating the universal identifier based on a base code and a series code.

30. The storage medium of claim 29, further comprising program instructions for generating the universal identifier based on a country code.

31. The storage medium of claim 29 further comprising program instructions for generating the universal identifier based on a base code having a postal code.

32. The storage medium of claim 24, further comprising program instructions for generating the universal identifier based on a base code and a country code.

33. The storage medium of claim 32, further comprising program instructions for generating the universal identifier based on a base code having a postal code.
